(19) United States
(12) Patent Application Publication
(10) Pub. No.: US 2006/0141203 A1
(43) Pub. Date: Jun. 29, 2006

(54) Optical recording material and optical recording medium

(75) Inventors: Atsushi Monden, Tokyo (JP); Masahiro Shinkai, Tokyo (JP); Junji Tanabe, Tokyo (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 11/103,602

(22) Filed: Apr. 12, 2005

(30) Foreign Application Priority Data
Apr. 21, 2004 (JP) P2004-126039

(51) Int. Cl. B32B 3/02

(52) U.S. Cl. 428/64.4

(57) ABSTRACT

The optical recording material of the invention is an optical recording material used for an optical recording medium capable of recording information by irradiation of light, the optical recording medium being an optical recording medium which records information at a linear speed of at least 14 m/sec, wherein the dye component in the optical recording material comprises at least one type of chelate compound of an azo compound and a metal, and when the dye component is used as a sample for thermogravimetry in an inert gas atmosphere, the dye component sample exhibits a maximum weight reduction of 0.2-3.0%/° C. at 180-250° C.

### BACKGROUND OF THE INVENTION

1. Field of the Invention

The present invention relates to an optical recording medium for recording of information by irradiation of light, and to an optical recording material used in the medium.

2. Related Background of the Invention

Conventional optical recording media record information by irradiation of light such as laser light on a recording layer to produce deformational changes, magnetic changes or phase changes in the recording layer. Such optical recording media include, for example, write-once optical recording media comprising recording layers which contain organic dyes such as azo compounds, and are widely used as CD-R (CD-Recordable) and DVD±R (DVD Recordable) media.

Of the write-once optical recording media mentioned above, CD-R media are usually formed by laminating a recording layer containing a dye as the major constituent component, a reflective layer composed mainly of metal and a protective layer composed of an ultraviolet curing resin or the like in that order on a round base with a guide groove. DVD±R media are formed by laminating the same layers as a CD-R, and adding an adhesive layer and a base on the protective layer.

The principle for recording and reading of information may be explained more specifically as follows. First, when laser or another form of light is irradiated onto the recording layer of the optical recording medium while moving it relative to the optical recording medium at a prescribed speed in the transverse direction, the irradiated light energy is absorbed by the dye component in the recording layer, thereby heating it. This results in thermal deformation of the laser light-irradiated regions and surrounding regions of the recording layer due to decomposition, vaporization and dissolution, thereby forming pits (this will hereinafter be referred to as the “recording principle”). In the case of a CD-R or DVD-R, the aforementioned movement of laser light is accomplished by rotating the disk in such a manner that the linear speed of the laser light with respect to the disk is constant.

For reading of the information, light is irradiated onto the recording layer which has the pits formed by thermal deformation, and a difference in reflectance of the light is produced between the pit sections and non-pit sections. The difference in reflectance is read by an optical detector and converted to electrical signal variations to allow reading of the information (this will hereinafter be referred to as the “reading principle”). Thus, it is difficult to read the information with adequate precision and accuracy unless the pits are formed at the proper sections and satisfactory recording characteristics are achieved.

One of the factors affecting the recording characteristics is the type of dye material used in the recording layer. A conventional method, which has been investigated for evaluating whether or not the recording layer contains a dye material conferring satisfactory recording characteristics, has been to employ thermogravimetry (TG) and/or differential thermal analysis (DTA) for one or more the different dye materials (hereinafter referred to as “dye components”) as constituents of the recording layer (see Japanese Patent Application Laid-Open No. 08-297838, Japanese Patent Application Laid-Open No. 09-58123, Japanese Patent Application Laid-Open No. 09-274732, Japanese Patent Application Laid-Open No. 10-6644, Japanese Patent Application Laid-Open No. 10-188341 and Japanese Patent Application Laid-Open No. 11-70732). There have also been proposed optical recording media comprising dye materials in the recording layer which satisfy prescribed evaluation criteria according to TG and/or DTA.

For example, the purpose of providing an optical recording medium suitable for recording at short wavelengths of 600-700 nm may be achieved in the manner described in Japanese Patent Application Laid-Open No. 09-58123, which discloses an optical recording medium wherein optical changes are produced in the recording layer by laser light with a wavelength of 600-700 nm, and wherein thermogravimetry of the organic dye shows a weight loss slope of at least 2%/° C. for the temperature during the main weight loss process (weight loss of 18% or greater), while thermogravimetry shows a total weight loss of 25% or greater during the main weight loss process.

Also, the purpose of providing an optical recording medium capable of high-density recording may be achieved in the manner described in Japanese Patent Application Laid-Open No. 10-6644, which proposes an optical recording medium wherein the recording layer comprises a mixture composed of a main component dye A which satisfies the condition of exhibiting a weight loss slope of between 0.5%/° C. and 3%/° C. based on temperature increase during the main weight loss process (weight loss of 15% or greater), according to thermogravimetry, with a loss of 40-55% of the total weight during the main weight loss process, or a weight loss slope of between 3%/° C. and 20%/° C. during the main weight loss process with a loss of 30-50% of the total weight during the main weight loss process; and a compound B which satisfies the condition of exhibiting a weight loss slope of at least 10%/° C. during the main weight loss process, with a loss of at least 55% of the total weight during the main weight loss process, or a weight loss slope of less than 10%/° C. during the main weight loss process with a loss of at least 75% of the total weight during the main weight loss process.

Also, the purpose of obtaining a high-capacity optical recording medium with high reflectance, suitable for short-wavelength recording, may be achieved in the manner described in Japanese Patent Application Laid-Open No. 10-188341, which discloses an optical recording medium wherein one of the following conditions is satisfied: the recording layer comprises an organic dye which, according to thermogravimetry, undergoes substantially no loss at temperatures lower than the initial temperature of the main loss and has a loss slope of at least 2%/° C. during the main loss process, with a total loss of 30% or greater, wherein based on differential thermal analysis the thermal peak size is between −10 μV/mg and 10 μV/mg and the peak width is no greater than 20° C., or on a recording layer comprising an organic dye wherein, based on differential thermal analysis, the thermal peak size is between 10 μV/mg and 30 μV/mg and the peak width is no greater than 20° C., there is formed a metal reflective layer wherein the reciprocal of the specific electrical resistance value near room temperature is between 0.20/μΩcm and 0.30/μΩcm, the refractive index with reproduction light of ±5 nm is between 0.1 and 0.2 and the extinction coefficient is between 3 and 5.

### SUMMARY OF THE INVENTION

In recent years there has been a need for higher bit densities in recording layers to allow recording of greater volumes of data on optical recording media, as well as a demand for higher speeds in linear recording (recording speeds) of information in order to shorten recording times.

However, based on detailed research by the present inventors with regard to conventional optical recording media including those described in the aforementioned patent documents, it was found that it is difficult to ensure sufficient recording characteristics during high-speed recording even when such dye components satisfying the conventional evaluation criteria are used in optical recording media. That is, it was found that when dye components satisfying the evaluation criteria described in the aforementioned patent documents are used as constituent materials of recording layers in order to achieve higher recording speeds, it becomes difficult to obtain the desired pit lengths, resulting in a tendency toward increased jitter and a higher error rate. This tendency becomes particularly notable when attempting to produce recording patterns with relatively short distances between pits, and it has been demonstrated to be especially prominent when such recording patterns are continuous, i.e. when performing high-density recording.

The object of the present invention is to provide an optical recording medium with sufficiently superior recording characteristics for high-speed recording, as well as an optical recording material to be used in such an optical recording medium.

As a result of much diligent research directed toward achieving the aforestated object, the present inventors discovered that if the thermal behavior of the dye component used in a recording layer differs in a specific manner from the thermal behavior conventionally known to be exhibited by dye components which confer excellent recording characteristics to media, then the optical recording medium employing the dye component will exhibit adequately superior recording characteristics, and the present invention was thereupon completed.

Specifically, the optical recording material of the invention is an optical recording material used for an optical recording medium capable of recording information by irradiation of light, the optical recording medium being an optical recording medium which records information at a linear speed of at least 14 m/sec, wherein the dye component in the optical recording material comprises at least one type of chelate compound of an azo compound and a metal, and when the dye component is used as a sample for thermogravimetry in an inert gas atmosphere, the dye component sample exhibits a maximum weight reduction of 0.2-3.0%/° C. at 180-250° C.

The optical recording medium of the invention is an optical recording medium capable of recording information at a linear speed of at least 14 m/sec by irradiation of light, wherein the recording layer provided on the optical recording medium comprises as a constituent material a dye component containing at least one type of chelate compound of an azo compound and a metal, and when the dye component is used as a sample for thermogravimetry in an inert gas atmosphere, the dye component sample exhibits a maximum weight reduction of 0.2-3.0%/° C. at 180-250° C.

According to the invention, “weight reduction” is the limit value of the mean weight reduction at a given temperature from a curve obtained by thermogravimetry (TG) conducted with a prescribed temperature elevating program (hereinafter referred to as “TG curve”). This will be explained in detail with reference to FIG. 1. The vertical and horizontal positional relationships are based on the positional relationships shown in FIG. 1, unless otherwise specified.

FIG. 1 is a graph showing the TG curve and temperature dependency of weight reduction. The horizontal axis represents the temperature surrounding the sample. The vertical axis represents sample weight (%) with respect to 100% at the start of analysis at the left side, and the weight reduction (%/° C.) at the right side. In TG according to the invention, change in the sample weight is measured while increasing the temperature surrounding the sample, and therefore progression of time is from the left to the right side in the graph of FIG. 1. The TG curve is expressed as the function y=f(x), where y is the weight (%) and x is the temperature surrounding the sample (° C.).

First, when the temperature surrounding the dye component sample is increased during TG, decomposition of the dye component causes a noticeable change in weight of the sample (weight reduction). For example, if the temperature surrounding the sample is increased by a small degree of h° C. from a given temperature a° C. to (a+h)° C., the weight change is (f(a+h)−f(a))%; when the weight change is positive the weight reduction is −(f(a+h)−f(a))%, and when the weight change is negative the weight reduction is (f(a+h)−f(a))%. In the case of a positive weight change, therefore, the mean weight reduction at a° C. is expressed as −(f(a+h)−f(a))/h (units: %/° C.), and in the case of a negative weight change the mean weight reduction at a° C. is expressed as (f(a+h)−f(a))/h (units: %/° C.). Also, the limit value of the mean weight reduction when the small degree h is approximately 0 is the weight reduction according to the invention (units: %/° C.), which is numerically expressed as −f′(a) when the weight change is positive and as f′(a) when the weight change is negative. In the case of FIG. 1 the weight change is negative, and therefore the weight reduction is f′(a). The weight reduction at the given temperature a° C. will usually be the negative of the slope of the tangent of the TG curve at a° C. Thus, the weight reduction can be calculated from the TG curve.

Although the reason why the optical recording material of the invention allows formation of an optical recording medium exhibiting excellent recording characteristics has not been fully elucidated at the current time, the present inventors believe part of the reason to be the following. However, the concept is not limited to the one explained here.

The recording layer dye components disclosed in the aforementioned patent documents of the prior art, which generally exhibit rapid weight reduction with increasing temperature according to TG, are considered satisfactory for producing optical recording media with excellent recording characteristics. Dye components exhibiting such thermal behavior exhibit their weight reduction only at relatively high temperatures, and therefore irradiation with high energy laser is necessary to form the pits. When the recording speed is a low speed such as 2×, i.e. a linear speed of 7 m/sec, problems do not usually arise in the recording characteristics even when high energy lasers are used for irradiation.

However, the present inventors believe that when high energy laser light is irradiated in sections with recording patterns wherein the distances between recording pits are short, the laser-generated heat is readily transferred to adjacent pits with increasing recording speed, tending to produce frequent heat interference between the pits. With high-speed recording of information at 4× speed or higher, i.e. a linear speed of 14 m/sec or greater, the heat interference between pits presumably results in increased jitter and a higher error rate.

On the other hand, the dye component of the optical recording material of the invention undergoes little weight reduction with increasing temperature according to TG within a prescribed relatively low temperature range. Since this type of dye component does not require a very high laser energy to be used for rapid pit formation, it should not produce the heat interference between pits described above even with high-speed recording. Consequently, the optical recording material of the invention may be used as a recording layer comprising a dye component exhibiting such thermal behavior in order to provide an optical recording medium with sufficiently superior recording characteristics regardless of the recording speed.

The optical recording material of the invention preferably has a weight reduction in the range of 0.2-3.0%/° C. at 180-250° C. according to TG as described above. An optical recording medium employing such an optical recording material will exhibit even more excellent recording characteristics.

The azo compound of the optical recording material of the invention preferably includes an azo compound represented by the following general formula (1) for further enhanced recording characteristics and light stability.

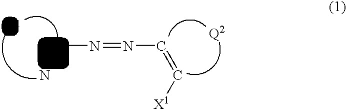

In the formula, Q¹ represents a divalent residue which binds to the nitrogen atom and to the carbon atom bound to the nitrogen atom to form a heterocycle or a fused ring containing a heterocycle, Q² represents a divalent residue which binds to the mutually bound carbon atoms to form a fused ring, and X¹ represents a functional group with one or more active hydrogen atoms.

The dye component more preferably contains a cyanine dye, where the cyanine dye preferably contains a group represented by the following general formula (2) or (3). 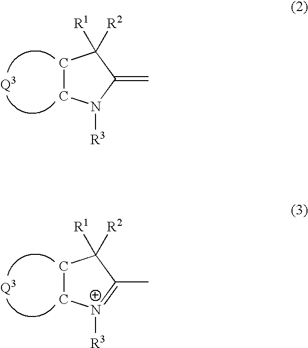
In the formula, Q³ represents an optionally substituted benzene ring or an optionally substituted naphthalene ring, R¹ and R² each independently represent C1-4 alkyl, cycloalkyl, phenyl or optionally substituted benzyl, or are linked together to form a 3- to 6-membered ring, and R³ represents C1-4 alkyl, cycloalkyl, alkoxy, phenyl or optionally substituted benzyl, the groups represented by R¹, R² and R³ being optionally substituted.

The optical recording medium of the invention more preferably comprises the aforementioned optical recording material as a constituent component of the recording layer.

According to the invention it is possible to provide an optical recording medium with sufficiently superior recording characteristics for high-speed recording, and an optical recording material to be used in such an optical recording medium.

### BRIEF DESCRIPTION OF THE DRAWINGS

FIG. 1 is a schematic graph illustrating weight reduction according to the invention.

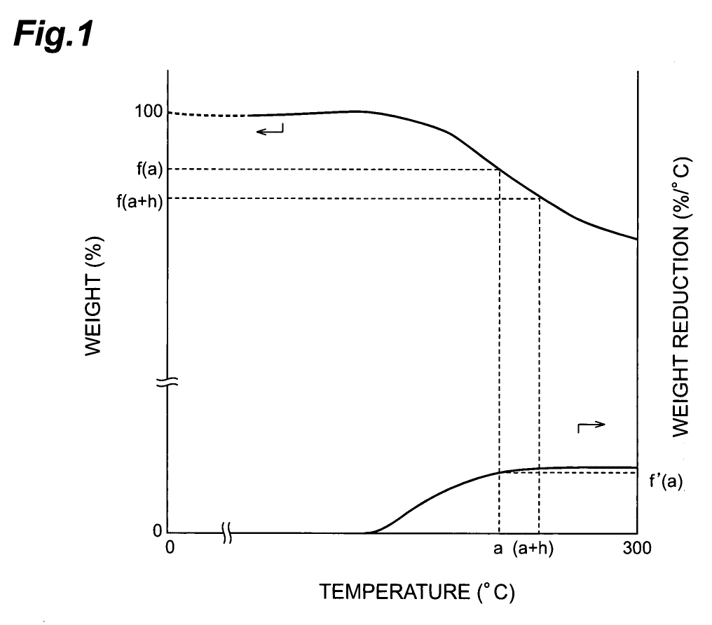

FIG. 2 is a graph schematically representing a TG curve for a dye component according to the invention.

FIG. 3 is a graph schematically representing a TG curve for a dye component which is not a dye component according to the invention.

FIG. 4 is a partial cross-sectional view showing an embodiment of an optical recording medium according to the invention.

FIG. 5 is a partial cross-sectional view showing a preferred embodiment of an optical recording medium according to the invention.

### DESCRIPTION OF THE PREFERRED EMBODIMENTS

The present invention will now be explained in greater detail using preferred embodiments of the invention, with reference to the drawings where necessary. Throughout the drawings, corresponding elements will be referred to with like reference numerals and will be explained only once. The vertical and horizontal positional relationships are based on the positional relationships shown in the drawings, unless otherwise specified. Also, the dimensional proportions of the drawings are not limited to the proportions illustrated.

An optical recording material according to a preferred embodiment of the invention will be explained first. The optical recording material of this embodiment comprises a dye component containing at least one type of azo compound, and when the dye component is used as a sample for thermogravimetry in an inert gas atmosphere, it exhibits a maximum weight reduction of 0.2-3.0%/° C. at 180-250° C. In order to add the dye component to the recording layer, a dye component consisting solely of a dye material obtained by synthesis or preparation by a publicly known method, or a known (commercially available) dye material, or else a dye component comprising a plurality of different dye materials, may be subjected to a repeated process of analysis and measurement by thermogravimetry (hereinafter abbreviated as “TG” where necessary), to obtain a dye component which satisfies the aforementioned conditions of weight reduction.

The types of other dye materials and their proportions in the dye component are not particularly restricted so long as the component exhibits the aforementioned weight reduction and comprises at least one type of chelate compound of an azo compound and a metal; a chelate compound may be used alone or two or more different chelate compounds may be used in combination, while a dye material with a different chelate compound may also be added to the chelate compound.

The azo compound is not particularly restricted so long as it is a compound with a functional group represented by —N═N—, and as examples there may be mentioned compounds having an aromatic ring bonded to the two nitrogen atoms, and more specifically the compounds represented by general formula (1) above. In formula (1), Q¹ represents a divalent residue which binds to the nitrogen atom and to the carbon atom bound to the nitrogen atom to form a heterocycle or a fused ring containing a heterocycle. Q² represents a divalent residue which binds to the mutually bound carbon atoms to form a fused ring.

X¹ is a functional group with one or more active hydrogen atoms, and for example, there may be mentioned hydroxyl (—OH), thiol (—SH), amino (—NH₂), carboxyl (—COOH), amide (—CONH₂), sulfonamide (—SO₂NH₂), sulfo (—SO₃H) and —NSO₂CF₃.

As such azo compounds there may be mentioned the compounds represented by the following general formulas (4) to (7).

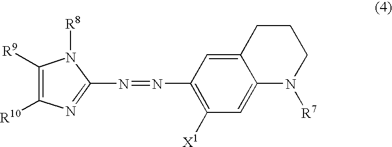

In the formula, R⁷ and R⁸ may be the same or different and each independently represents C1-4 alkyl, R⁹ and R¹⁰ may be the same or different and each independently represents nitrile or a carboxylic acid ester group, and X¹ has the same definition as above. Preferred carboxylic acid ester groups are —COOCH₃, —COOC₂H₅ and —COOC₃H₇.

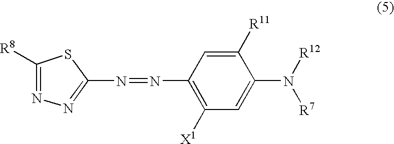

In the formula, R¹¹ represents hydrogen or C1-3 alkoxy, R¹², R⁷ and R⁸ may be the same or different and each independently represents C1-4 alkyl, and X¹ has the same definition as above.

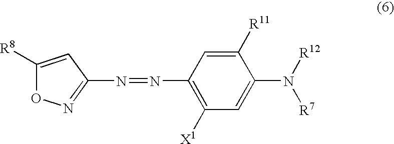

In the formula, R¹¹, R¹², R⁷, R⁸ and X¹ have the same respective definitions as R¹¹, R¹², R⁷, R⁸ and X¹ in formula (5).

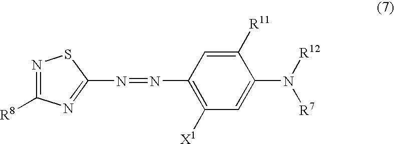

In the formula, R¹¹, R¹², R⁷, R⁸ and X¹ have the same respective definitions as R¹¹, R¹², R⁷, R⁸ and X¹ in formula (5).

As metals (central metals) of the aforementioned chelate compound there may be mentioned titanium (Ti), vanadium (V), chromium (Cr), manganese (Mn), iron (Fe), cobalt (Co), nickel (Ni), copper (Cu), zirconium (Zr), niobium (Nb), molybdenum (Mo), ruthenium (Ru), rhodium (Rh), palladium (Pd), silver (Ag), cadmium (Cd), indium (In), tin (Sn), antimony (Sb), tungsten (W), rhenium (Re), osmium (Os), iridium (Ir), platinum (Pt) and gold (Au). Alternatively, V, Mo and W may be in the form of the oxide ions, VO²⁺, VO³⁺, MoO²⁺, MoO³⁺, WO³⁺ and the like.

As examples for the chelate compound there may be mentioned the compounds represented by the following general formulas (8), (9) and (10), and the compounds represented in the following Tables 1 to 6 (Nos. A1-A49). These chelate compounds may be used alone or in combinations. In the chelate compounds represented as Nos. A1-A49, two azo compounds are coordinated with one central metal element. Where two different azo compounds or central metals are shown they are present in a molar ratio of 1:1, and where the central metal is indicated as “V═O”, the azo compound is coordinated with acetylacetone vanadium.

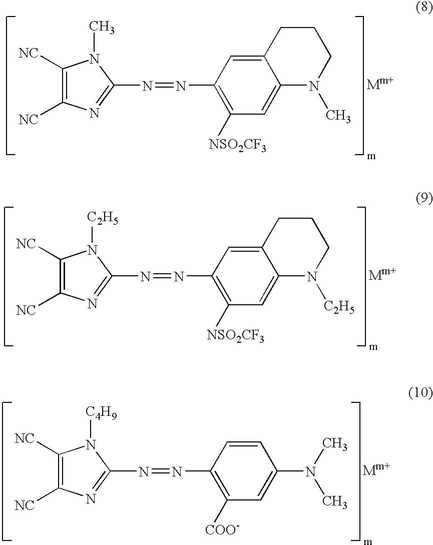

M in general formulas (8), (9) and (10) represents Ni²⁺, Co²⁺ or Cu²⁺, and m represents the valency of M.

TABLE 1

| No. | Azo compound | Central metal |
|---|---|---|
| A1 | 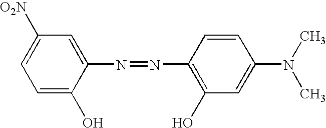 | Co |
| A2 | 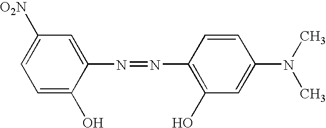 | V═O |
| A3 | 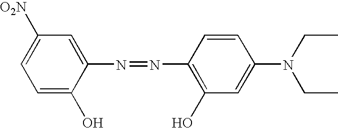 | Co |
| A4 | 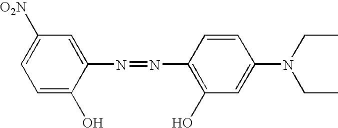 | V═O |
| A5 | 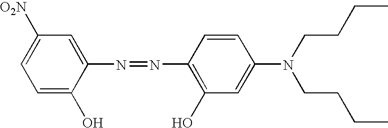 | Co |
| A6 | 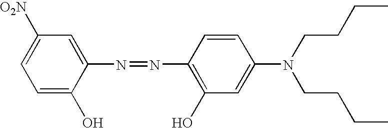 | V═O |
| A7 | 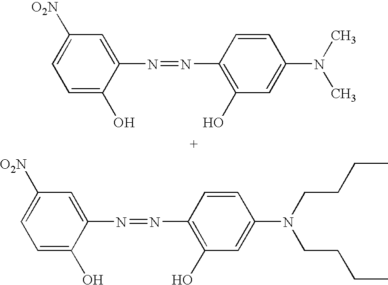 | Co |
| A8 | 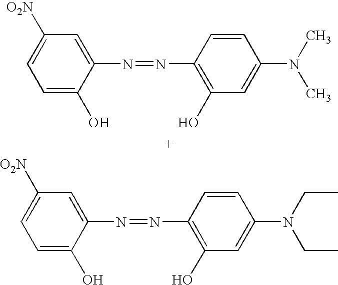 | Co |

TABLE 2

| No. | Azo compound | Central metal |
|---|---|---|
| A9 | 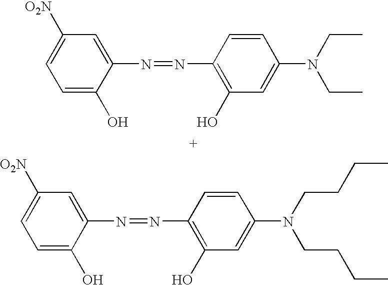 | Co |
| A10 | 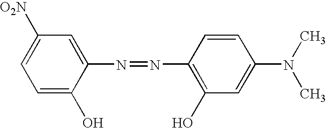 | Co +V═O |
| A11 | 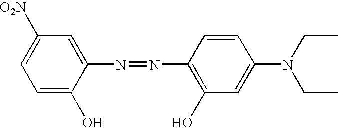 | Co +V═O |
| A12 | 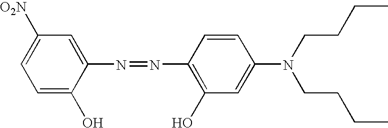 | Co +V═O |
| A13 | 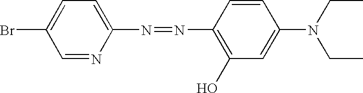 | Cu |
| A14 | 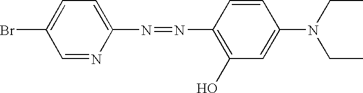 | Ni |
| A15 | 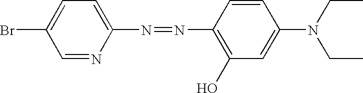 | Co |
| A16 | 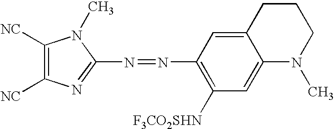 | Ni |
| A17 | 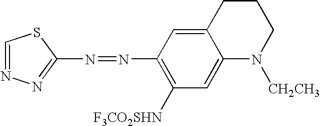 | Ni |

TABLE 3

| | | Central |
|---|---|---|
| No. | Azo compound | metal |
| A18 | 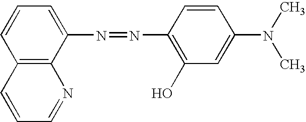 | Co |
| A19 | 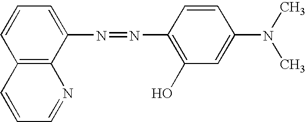 | Ni |
| A20 | 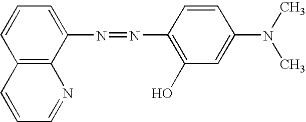 | Cu |
| A21 | 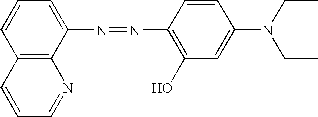 | Co |
| A22 | 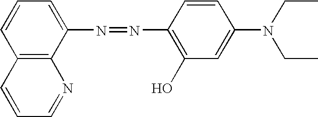 | Ni |
| A23 | 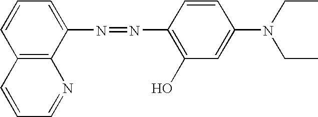 | Cu |
| A24 | 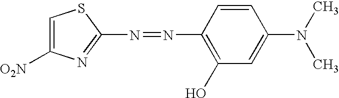 | Cu |
| A25 | 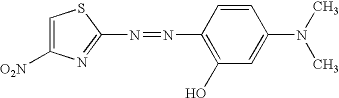 | Ni |
| A26 | 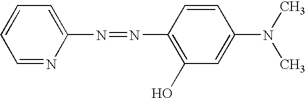 | Cu |
| A27 | 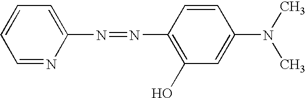 | Ni |

TABLE 4

| No. | Azo compound | Central metal |
|---|---|---|
| A28 | 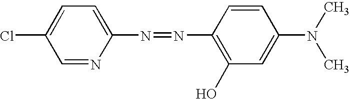 | Cu |
| A29 | 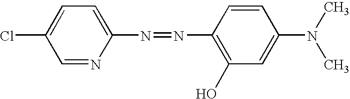 | Ni |
| A30 | 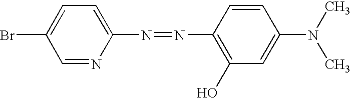 | Cu |
| A31 | 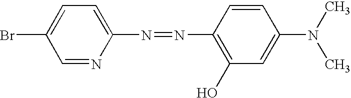 | Ni |
| A32 | 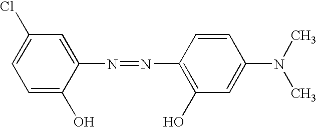 | Co |
| A33 | 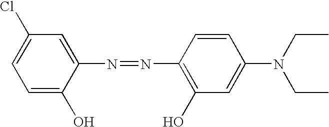 | Co |
| A34 | 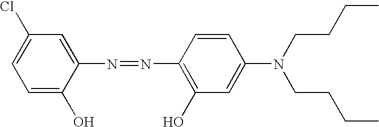 | Co |
| A35 | 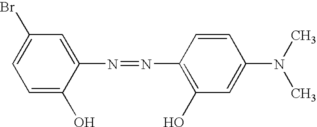 | Co |
| A36 | 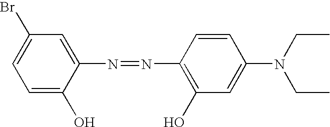 | Co |
| A37 | 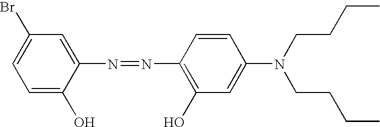 | Co |

TABLE 5

| No. | Azo compound | Central metal |
|---|---|---|
| A38 | 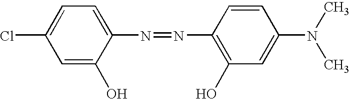 | Co |
| A39 | 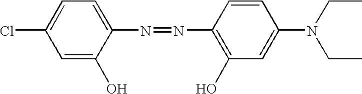 | Co |
| A40 | 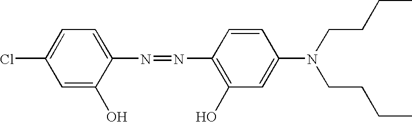 | Co |
| A41 | 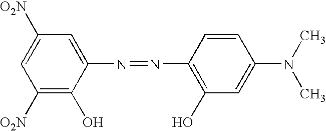 | Co |
| A42 | 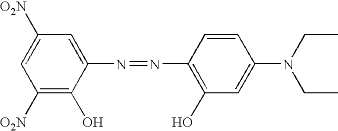 | Co |
| A43 | 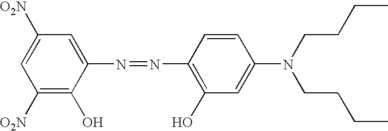 | Co |
| A44 | 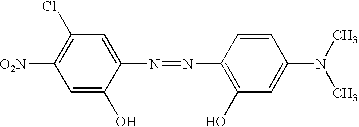 | Co |
| A45 | 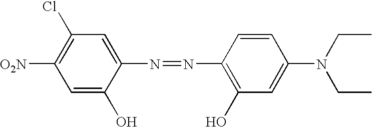 | Co |
| A46 | 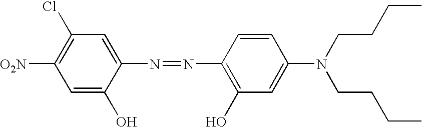 | Co |
| A47 | 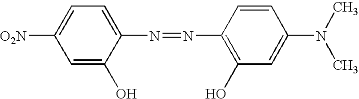 | Co |

TABLE 6

| No. | Azo compound | Central metal |
|---|---|---|
| A48 | 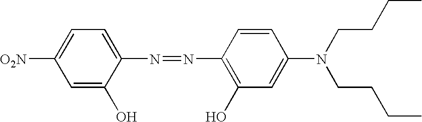 | Co |
| A49 | 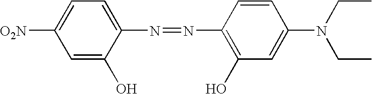 | Co |

Among these compounds there are preferred the chelate compounds represented as A13-A31. An alternative is the structure of compound A49 with the nitro and diethylamino groups removed from the molecule.

Depending on the nature of X¹, the chelate compound formed may have the active hydrogen of X¹ dissociated.

The aforementioned dye component may also contain a counter cation if the chelate compound exists as an anion, or a counter anion if the chelate compound exists as a cation. As counter cations there are preferably used alkali metal ions such as Na⁺, Li⁺ and K⁺, ammonium ion or the like. Cyanine dye described below may also be used as a counter cation for salt formation. As counter anions there are preferably used PF₆⁻, I⁻, BF₄⁻ and anions represented by the following formula (11).

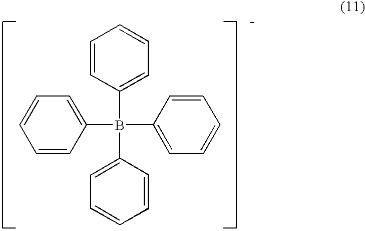

The chelate compound may be synthesized according to a publicly known process (for example, see Furukawa, Anal. Chem. Acta., 140, 289(1982)).

There are no particular restrictions on dye materials other than the aforementioned chelate compounds to be included in the dye component, and they may be publicly known materials or materials which can be synthesized by publicly known processes or according to publicly known processes; there may be mentioned cyanine dyes, squalium dyes, croconium dyes, azulenium dyes, xanthene dyes, melocyanine dyes, triarylamine dyes, anthraquinone dyes, indoaniline metal complex dyes, azomethine dyes, oxonol dyes and intramolecular CT dyes. Cyanine dyes are preferred among these, and cyanine dyes having a group represented by general formula (2) or (3) above are especially preferred. In formulas (2) and (3), Q³ represents a group of atoms forming an optionally substituted benzene ring or an optionally substituted naphthalene ring, R¹ and R² each independently represent C1-4 alkyl, cycloalkyl, phenyl or optionally substituted benzyl, or are linked together to form a 3- to 6-membered ring, and R³ represents C1-4 alkyl, cycloalkyl, alkoxy, phenyl or optionally substituted benzyl, the groups represented by R¹, R² and R³ being optionally substituted.

As such cyanine dyes there may be mentioned cyanine dyes represented by the following general formula (12). 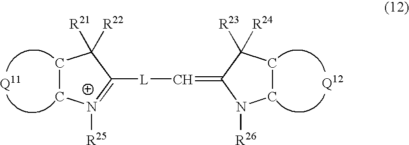
In the formula, L represents a divalent linking group represented by formula (13a) below, R²¹ and R²² each independently represent C1-4 alkyl or optionally substituted benzyl, or are linked together to form a 3- to 6-membered ring, R²³ and R²⁴ each independently represent C1-4 alkyl or optionally substituted benzyl, or are linked together to form a 3- to 6-membered ring, R²⁵ and R²⁶ each independently represent C1-4 alkyl or aryl, and Q¹¹ and Q¹² each independently represent a group of atoms forming an optionally substituted benzene ring or an optionally substituted naphthalene ring, provided that at least one from among R²¹, R²², R²³ and R²⁴ represents a non-methyl group, and the divalent linking group represented by formula (13a) below may have a substituent.

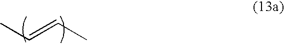

As more specific examples there may be mentioned the compounds (Nos. T1-T67) shown in Tables 7-12 below.

TABLE 7
No.

| | |
|---|---|
| T1 | 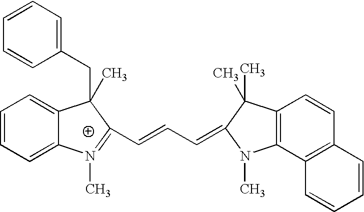 |
| T2 | 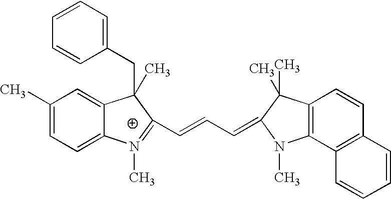 |
| T3 | 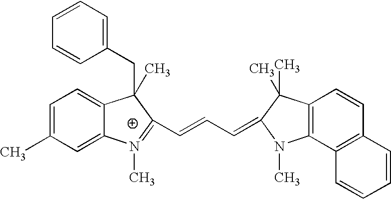 |
| T4 | 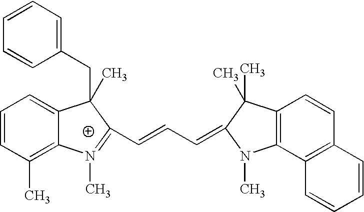 |
| T5 | 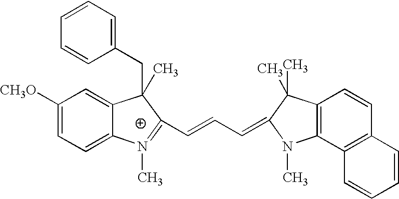 |
| T6 | 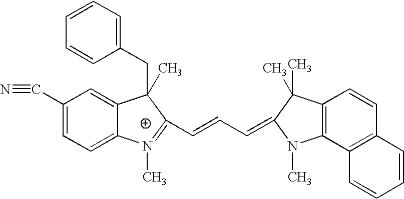 |
| T7 | 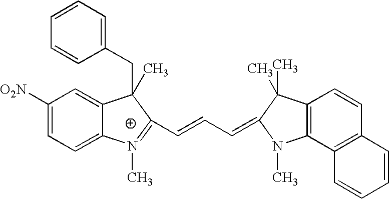 |
| T8 | 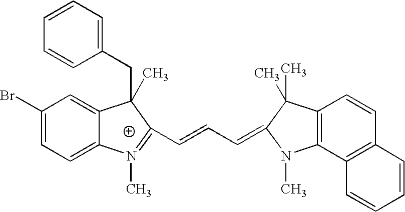 |
| T9 | 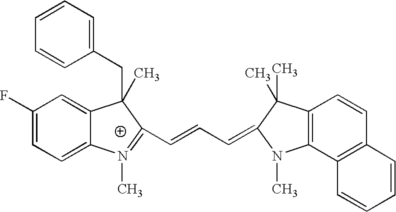 |
| T10 | 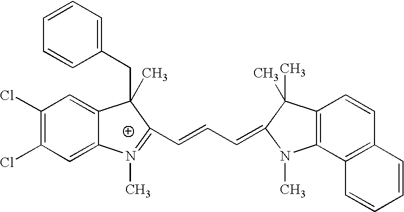 |
| T11 | 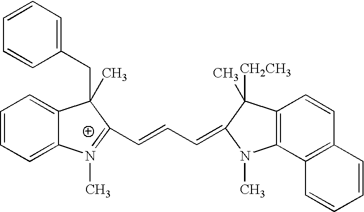 |
| T12 | 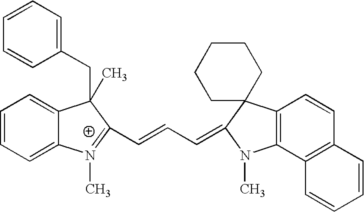 |

TABLE 8
No.

| | |
|---|---|
| T13 | 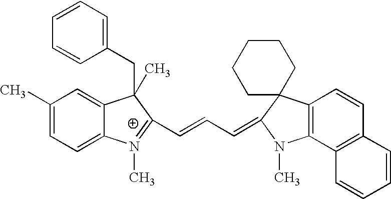 |
| T14 | 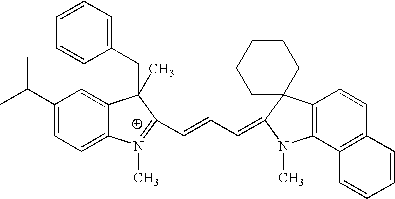 |
| T15 | 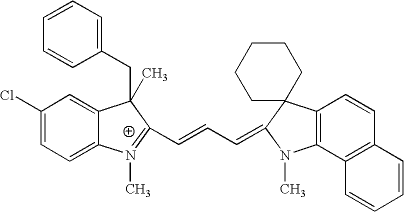 |
| T16 | 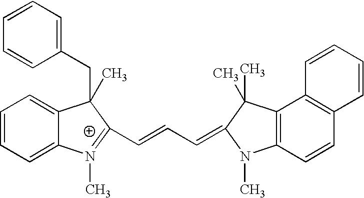 |
| T17 | 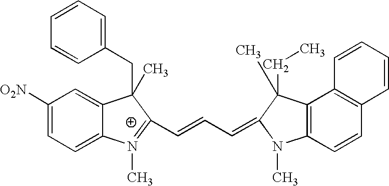 |
| T18 | 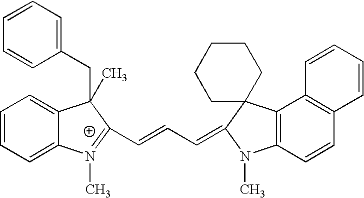 |
| T19 | 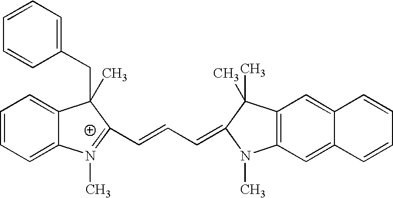 |
| T20 | 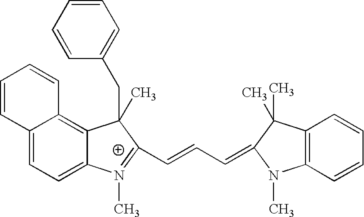 |
| T21 | 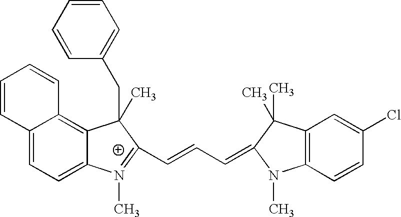 |
| T22 | 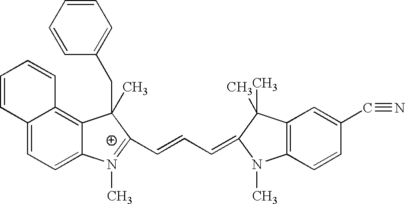 |
| T23 | 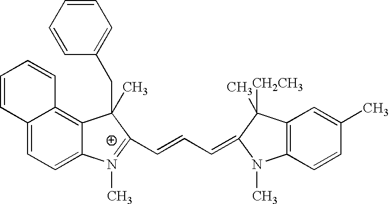 |
| T24 | 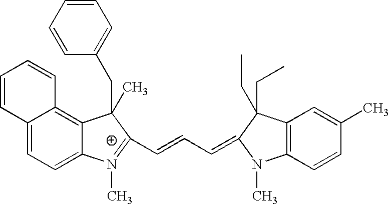 |

TABLE 9
No.

| | |
|---|---|
| T25 | 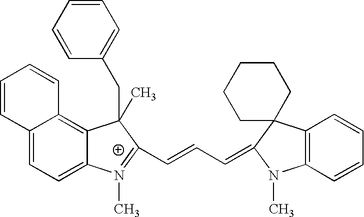 |
| T26 | 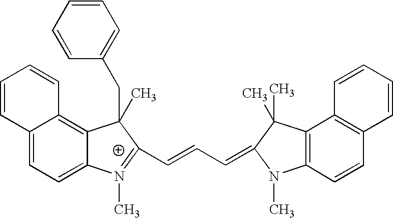 |
| T27 | 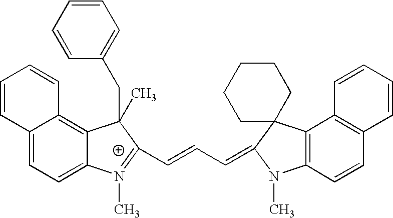 |
| T28 | 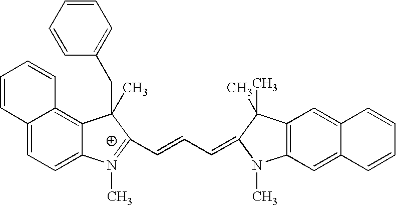 |
| T29 | 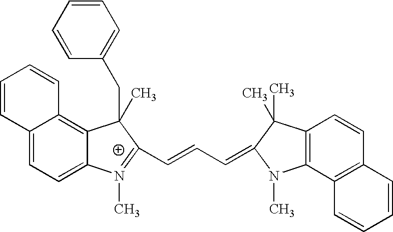 |
| T30 | 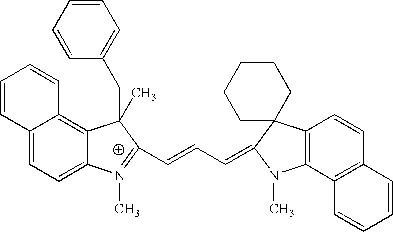 |
| T31 | 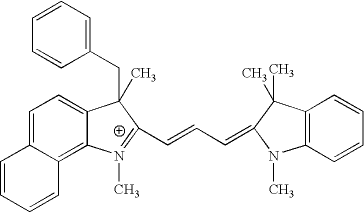 |
| T32 | 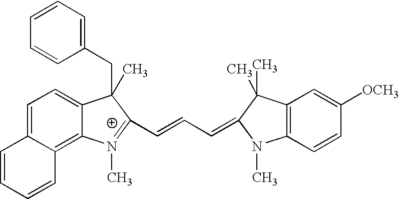 |
| T33 | 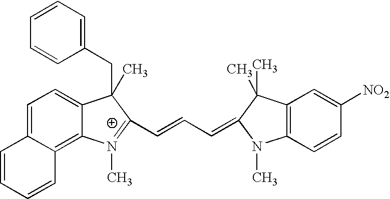 |
| T34 | 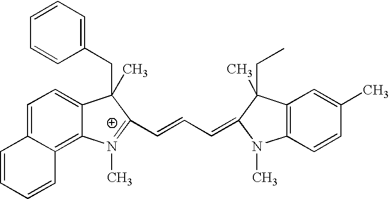 |
| T35 | 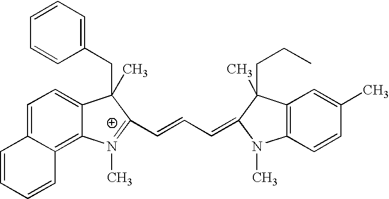 |
| T36 | 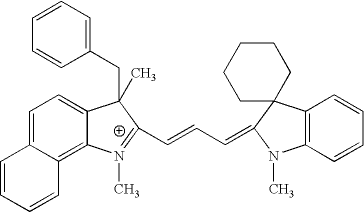 |

TABLE 10
No.

| | |
|---|---|
| T37 | 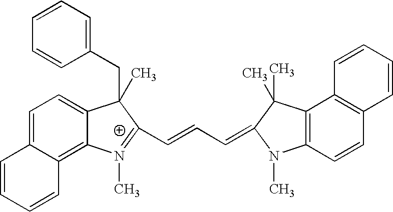 |
| T38 | 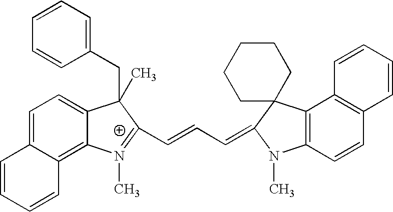 |
| T39 | 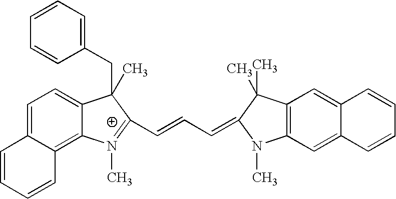 |
| T40 | 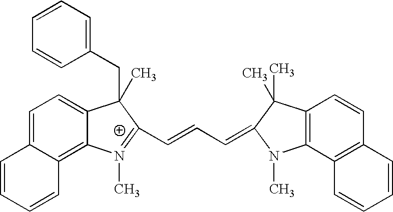 |
| T41 | 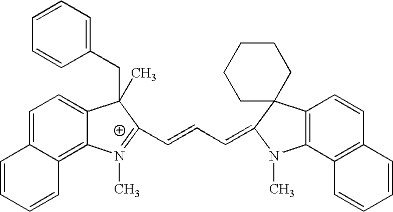 |
| T42 | 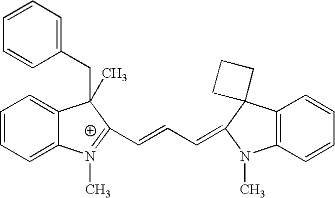 |
| T43 | 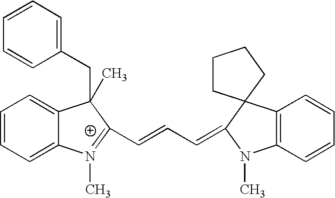 |
| T44 | 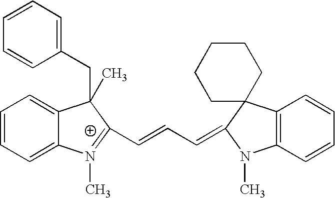 |
| T45 | 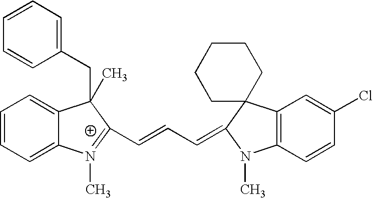 |
| T46 | 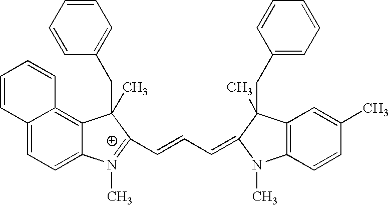 |
| T47 | 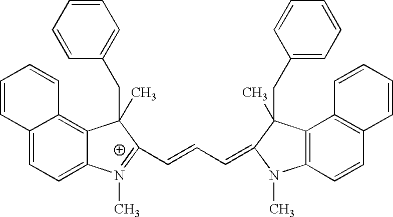 |
| T48 | 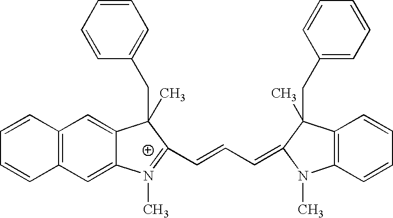 |

TABLE 11
No.

| | |
|---|---|
| T49 | 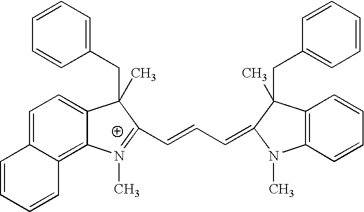 |
| T50 | 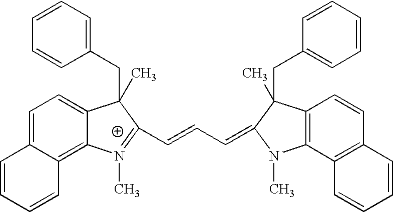 |
| T51 | 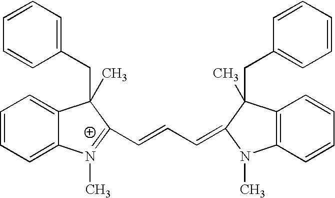 |
| T52 | 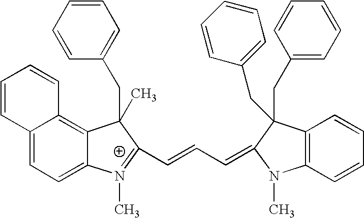 |
| T53 | 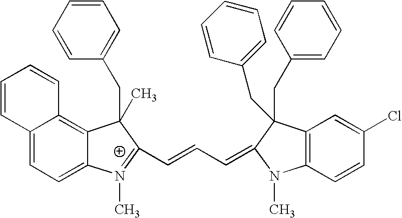 |
| T54 | 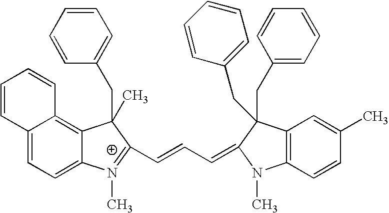 |
| T55 | 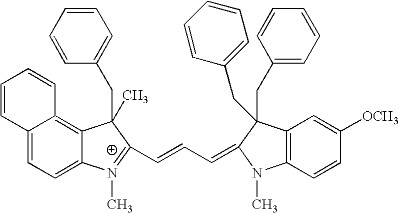 |
| T56 | 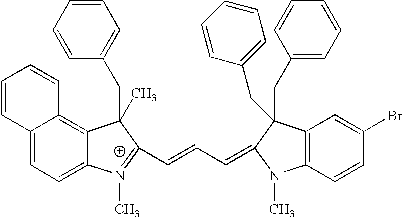 |
| T57 | 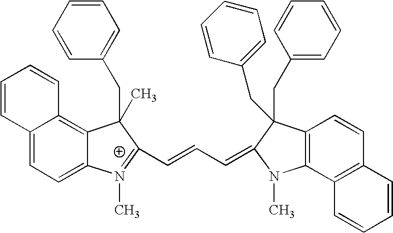 |
| T58 | 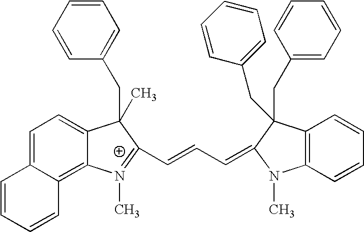 |
| T59 | 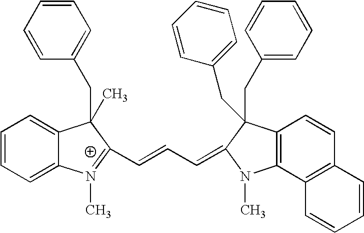 |
| T60 | 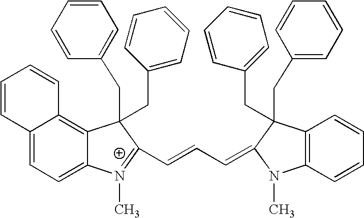 |

TABLE 12
No.

| | |
|---|---|
| T61 | 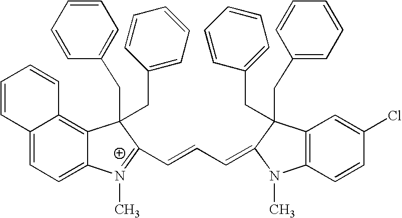 |
| T62 | 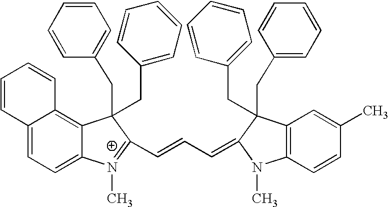 |
| T63 | 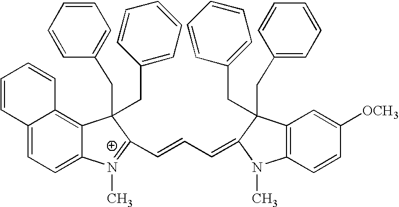 |
| T64 | 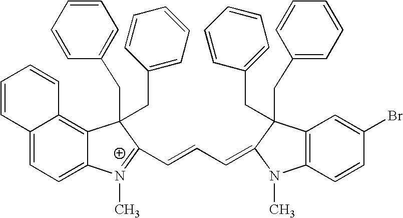 |
| T65 | 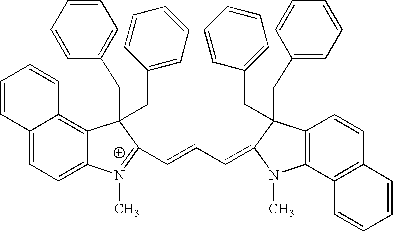 |
| T66 | 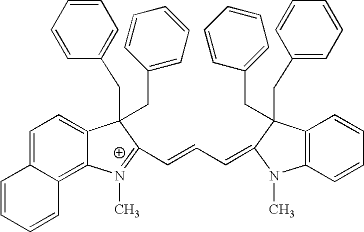 |
| T67 | 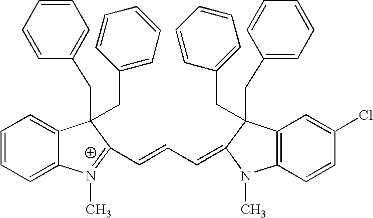 |

There are no particular restrictions on the apparatus used for thermogravimetry for measurement of the weight reduction of the dye components described above, and any conventional publicly known apparatus may be employed. The sample (dye component) amount is not particularly restricted so long as it allows measurement of the weight reduction of the sample within the range permitted by the apparatus. The inert gas in the atmosphere may be, for example, nitrogen or a noble gas such as Ar, He or Ne. The flow rate of the inert gas is not particularly restricted so long it allows the gas generated by decomposition of the sample to be rapidly purged from around the sample.

In order to obtain a dye component according to this embodiment, TG is conducted by gradually raising the temperature around the sample, and the temperature elevating program is preferably temperature increase by a fixed proportion per unit time. The temperature elevating rate (° C./min) in this case is not particularly restricted but is preferably about 5-20° C./min from the standpoint of measuring stability.

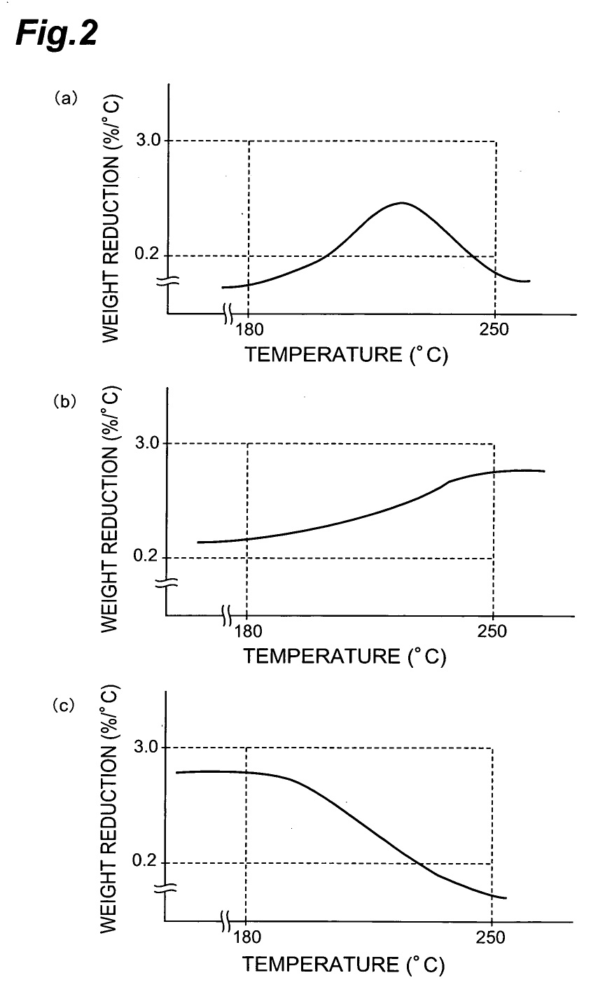

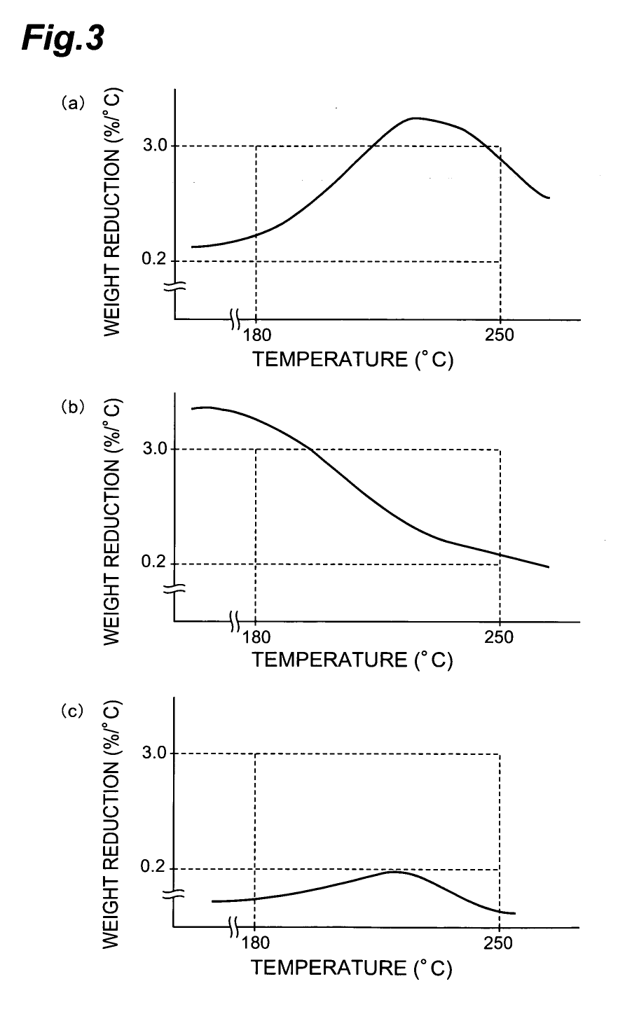

FIGS. 2(a) to 2(c) schematically show curves representing the temperature dependency of weight reduction for a sample according to the invention, i.e. wherein the maximum value of the weight reduction is 0.2-3.0%/° C. at 180-250° C., the weight reduction being calculated from the TG curve obtained as a result of TG performed in the manner described above, and FIGS. 3(a) to 3(c) schematically show curves for a sample outside of the scope of the invention. When the maximum value of the weight reduction at 180-250° C. is less than 0.2%/° C., a higher degree of laser energy will probably be necessary for pit formation, thus tending to increase jitter and leading to a higher error rate. If the maximum value of the weight reduction at 180-250° C. is greater than 3.0%/° C., the heat generation occurring with weight reduction (decomposition, etc.) will be increased, thus tending to produce heat interference between the pits.

Preferred from the standpoint of forming an optical recording medium with more excellent recording characteristics is a dye component which exhibits thermal behavior wherein a weight reduction of 0.2-3.0%/° C. is maintained at 180-250° C., as shown in FIG. 2(b).

The dye component included in the optical recording material of this embodiment more preferably is one without a maximum value for the weight reduction in the temperature range of below 180° C. according to the TG curve. A dye component having a maximum value for the weight reduction in the temperature range of below 180° C. may cause reading defects.

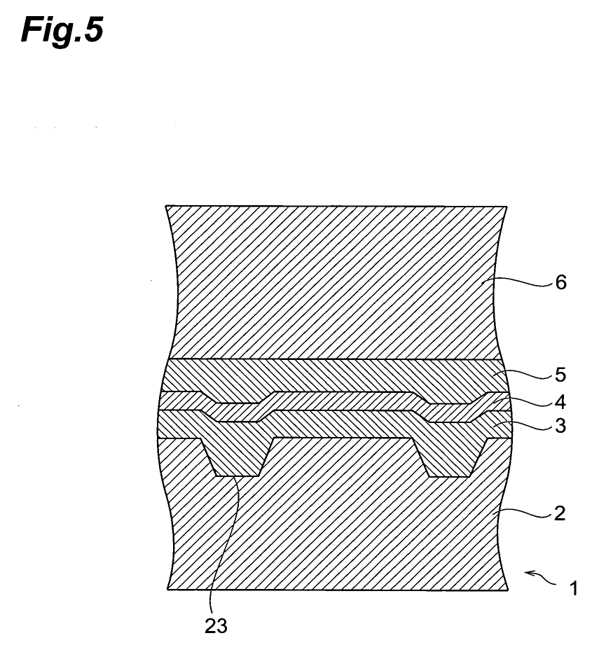

An optical recording medium according to this embodiment will now be explained. FIG. 5 is a partial cross-sectional view showing a preferred embodiment of an optical recording disk with an optical recording medium of the invention. The optical recording disk 1 shown in FIG. 5 has a laminated structure formed by bonding a recording layer 3, reflective layer 4, protective layer 5 and base 6 in that order on a base 2. The optical recording disk 1 is a write-once optical recording disk, capable of recording and reading with light having a short wavelength of 630-685 nm.

The base 2 and base 6 are disk-shaped with a diameter of about 64-200 mm and a thickness of about 0.6 mm each. Recording and reading are accomplished from the back side of the base 2 (opposite side to the base 6). Thus, at least the base 2 must have essential transparency for the recording light and reading light. More specifically, the base 2 preferably has a transmittance of at least 88% for the recording light and reading light. The material of the base 2 is preferably a resin or glass satisfying the aforementioned conditions for transmittance, and particularly preferred are thermoplastic resins such as polycarbonate resins, acrylic resins, amorphous polyethylene, TPX, polystyrene and the like. On the other hand, the material of the base 6 is not particularly restricted and may be, for example, the same material as the base 2.

The side of the base 2 on which the recording layer 3 is to be formed has a tracking groove 23 formed as a depression. The groove 23 is preferably a continuous spiral groove, preferably with a depth of 0.1-0.25 μm, a width of 0.20-0.50 μm and a groove pitch of 0.6-1.0 μm. Constructing the groove in this manner will allow a satisfactory tracking signal to be obtained without reducing the reflection level of the groove. The groove 23 may be formed simultaneously with molding of the base 2 by extrusion molding using the aforementioned resin, but alternatively a resin layer having a groove 23 may be formed by the 2P method after manufacture of the base 2, and a composite base subsequently formed from the base 2 and the resin layer.

The recording layer 3 is formed using an optical recording material according to the embodiment described above. The recording layer 3 may be formed by coating the base 2 with a mixed solution obtained by dissolving or dispersing the optical recording material of the invention in a solvent and removing the solvent from the coated film. As solvents for the mixed solution there may be mentioned alcohol-based solvents (including alkoxyalcohol-based solvents such as ketoalcohols and ethyleneglycol monoalkyl ethers), aliphatic hydrocarbon-based solvents, ketone-based solvents, ester-based solvents, ether-based solvents, aromatic-based solvents and halogenated alkyl-based solvents, among which alcohol-based solvents and aliphatic hydrocarbon-based solvents are preferred.

The alcohol-based solvent is preferably alkoxyalcohol-based or ketoalcohol-based. An alkoxyalcohol-based solvent preferably has an alkoxy portion of 1-4 carbon atoms and an alcohol portion of 1-5 carbon atoms, or more preferably 2-5 atoms, with a total of 3-7 carbon atoms. More specifically there may be mentioned ethyleneglycol monoalkyl ethers (cellosolves) such as ethyleneglycol monomethyl ether (methyl cellosolve), ethyleneglycol monoethyl ether (also known as ethyl cellosolve and ethoxyethanol), butylcellosolve and 2-isopropoxy-1-ethanol, or 1-methoxy-2-propanol, 1-methoxy-2-butanol, 3-methoxy-1-butanol, 4-methoxy-1-butanol and 1-ethoxy-2-propanol. As a keto alcohol there may be mentioned diacetone alcohol. Fluorinated alcohols such as 2,2,3,3-tetrafluoropropanol may also be used.

As aliphatic hydrocarbon-based solvents there are preferred n-hexane, cyclohexane, methylcyclohexane, ethylcyclohexane, cyclooctane, dimethylcyclohexane, n-octane, iso-propylcyclohexane and t-butylcyclohexane, among which ethylcyclohexane, dimethylcyclohexane and the like are especially preferred.

As a ketone-based solvent there may be mentioned cyclohexanone.

According to this embodiment, alkoxyalcohols such as ethyleneglycol monoalkyl ethers are preferred, and particularly ethyleneglycol monoethyl ether, 1-methoxy-2-propanol and 1-methoxy-2-butanol. The solvent used may be a single type, or it may be a mixed solvent of two or more types. For example, a mixed solvent of ethyleneglycol monoethyl ether and 1-methoxy-2-butanol is suitable for use.

The mixture may also contain binders, dispersing agents, stabilizers and the like as appropriate, in addition to the components mentioned above.

As methods for coating the mixture there may be mentioned spin coating, gravure coating, spray coating and dip coating, among which spin coating is preferred.

The thickness of the recording layer 3 formed in this manner is preferably 50-300 nm. Outside of this range the reflectance will be lowered, making it difficult to achieve a level of reading conforming to DVD standards. If the thickness of the recording layer 3 is at least 100 nm, and especially 130-300 nm, at the position above the groove 23, a very large modulation factor will be realized.

The extinction coefficient (imaginary part of the complex refractive index k) of the recording layer 3 for the recording light and reading light is preferably 0-0.20. If the extinction coefficient is greater than 0.20, sufficient reflectance may not be achieved. The refractive index (real part of the complex refractive index n) of the recording layer 3 is preferably at least 1.8. If the refractive index is less than 1.8, the modulation factor of the signal will tend to be smaller. The upper limit for the refractive index is not particularly restricted, but it will normally be about 2.6 for convenience of the organic dye synthesis.

The extinction coefficient and refractive index of the recording layer 3 may be determined according to the following procedure. First, a measurement sample is fabricated by forming a recording layer of about 40-100 nm on a prescribed transparent base, and then the reflectance through the measurement sample base or the reflectance from the recording layer side is measured. In this case, the reflectance is measured based on mirror reflection (about 5°) using the wavelength of the recording and reading light. The light transmittance of the sample is also measured. The measured values are used to calculate the extinction coefficient and refractive index according to the method described in, for example, “Kogaku [Optics]”, K. Ishiguro, pp. 168-178, Kyoritsu Zensho Publishing.

A reflective layer 4 is provided on the recording layer 3 by bonding onto the recording layer 3. The reflective layer 4 may be formed by vapor deposition, sputtering or the like using a metal or alloy with high reflectance. As metals and alloys there may be mentioned gold (Au), copper (Cu), aluminum (Al), silver (Ag), AgCu and the like. The thickness of the reflective layer 4 formed in this manner is preferably 10-300 nm.

On the reflective layer 4 there is formed a protective layer 5 by bonding onto the reflective layer 4. The protective layer 5 may be in layer or sheet form, and for example, it may be formed by coating the reflective layer 4 with a coating solution containing a material such as an ultraviolet curing resin and drying the coated solution if necessary. The coating may be accomplished by appropriate spin coating, gravure coating, spray coating, dip coating or the like. The thickness of the protective layer 5 formed in this manner is preferably 0.5-100 μm.

On the protective layer 5 there is formed a base 6 by bonding to the protective layer 5. The base 6 may have the same material composition and thickness as the base 2, and it may optionally have a groove formed therein. In order to further increase adhesion between the base 6 and the protective layer 5, an adhesive layer as described below may be provided on the protective layer 5, with the base 6 formed thereover.

During writing or reading of the optical recording disk 1 having this construction, recording light of a prescribed wavelength is irradiated in pulse form from the back side of the base 2 to vary the photoreflectance of the irradiated section. At this time, the optical recording disk 1 on which the recording layer 3 comprising the dye component of the invention is formed allows jitter to be adequately prevented at high density recording pattern sections having relatively narrow pitch distances, thus sufficiently preventing error rate increase, even in the case of high-speed recording of at least 4× speed, i.e. a linear speed of 14 m/sec.

The aforementioned embodiment was explained for an optical recording disk provided with a single recording layer 3 as the recording layer, but a plurality of recording layers may also be provided, with different dyes in each layer. This will allow recording and reading of information to be accomplished by a plurality of different recording and reading light beams with either the same or different wavelengths.

The optical recording disk 1 obtained in this manner may also be used by attaching together two optical recording disks 1, or a single optical recording disk 1 and another optical recording disk having a different construction from the optical recording disk 1, with their light-incident sides (base 2 sides) facing outward.

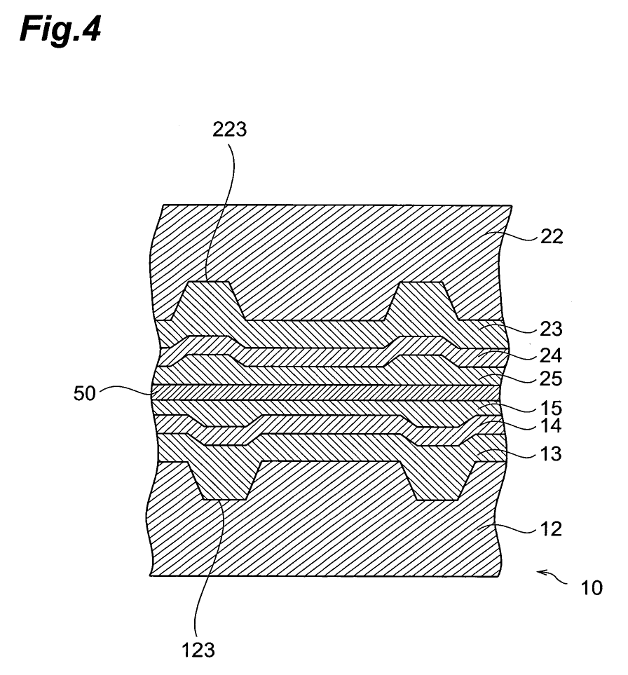

FIG. 4 is a partial cross-sectional view showing a preferred embodiment of an optical recording disc according to the attachment mode described above. The optical recording disk 10 shown in FIG. 4 has a laminated structure comprising a base 12, a recording layer 13, a reflective layer 14, a protective layer 15, an adhesive layer 50, a protective layer 25, a reflective layer 24, a recording layer 23 and a base 22 formed in that order. That is, the optical recording disk 10 has a construction wherein two optical recording disks having the same construction as the optical recording disk 1 shown in FIG. 5 are attached together with their respective protective layers facing and sandwiching the adhesive layer 50. The optical recording disk 10 is a write-once digital video disk conforming to the DVD standard, whereby recording and reading are accomplished by light with a short wavelength of 650 nm.

The adhesive layer 50 used may be a hot-melt adhesive, ultraviolet curing adhesive, thermosetting adhesive, tacky adhesive or the like, and it may be formed by an appropriate method such as, for example, roll coating, screen printing, spin coating or the like. For a DVD±R, screen printing or spin coating using an ultraviolet curing adhesive is preferred from the standpoint of overall balance between workability, productivity and disk characteristics. The thickness of the adhesive layer 50 is preferably about 10-200 μm.

The bases 12 and 22, the recording layers 13 and 23, the reflective layers 14 and 24 and the protective layers 15 and 25 are formed of the same materials and by the same method as for the optical recording disk 1 shown in FIG. 5. The thicknesses of the bases 12 and 22 are preferably about 0.6 mm. Grooves 123 and 223 are formed on the side of the base 12 on which the recording layer 13 is formed and on the side of the base 22 on which the recording layer 23 is formed, respectively. The grooves 123 and 223 preferably have depths of 60-200 nm, widths of 0.2-0.5 μm and groove pitches of 0.6-1.0 μm. The thicknesses of the recording layers 13 and 23 are preferably 50-300 nm, and the complex refractive index for light of 650 nm is preferably n 1.8-2.6, k=0.02-0.20.

### EXAMPLES

The present invention will now be explained in greater detail through examples, with the understanding that the examples are in no way limitative on the invention.

(Thermogravimetry of Dye Components)

The following dye materials S1-S9 were synthesized by ordinary methods. The obtained dye materials, or dye components prepared by combining two of the dye materials, were used as samples for thermogravimetry. The samples used were Nos. 1-9 shown in

Table 13. The values in parenthesis in Table 13 represent the molar mixing ratios of the dye materials.

No.

| | |
|---|---|
| S1 | 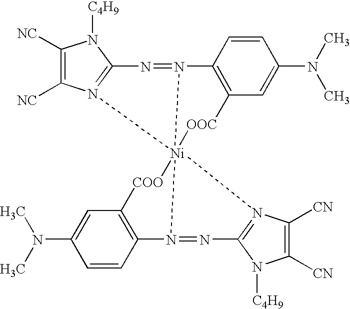 |
| S2 | 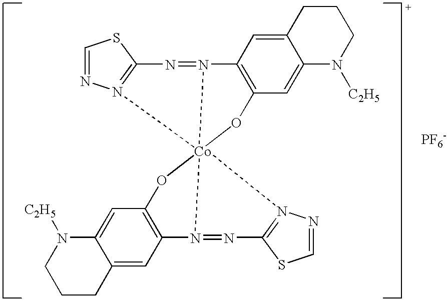 |
| S3 | 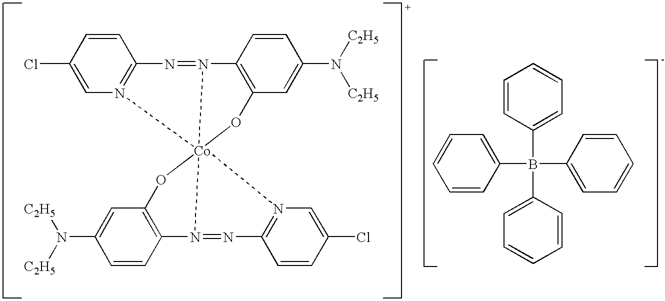 |
| S4 | 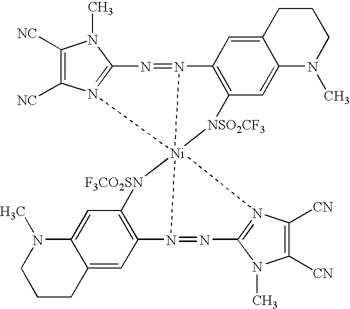 |
| S5 | 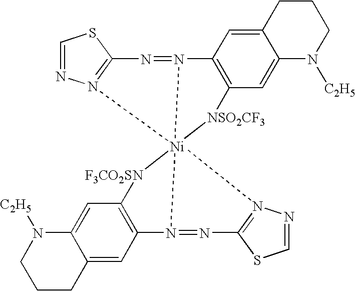 |
| S6 | 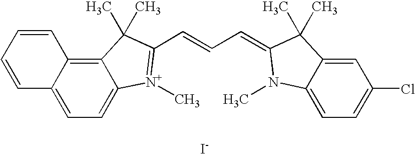 |
| S7 | 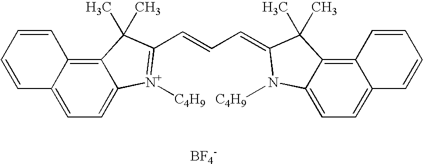 |
| S8 | 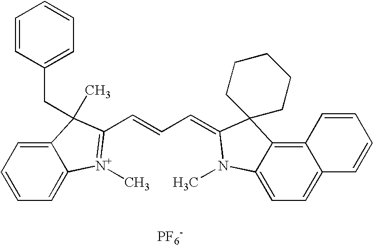 |
| S9 | 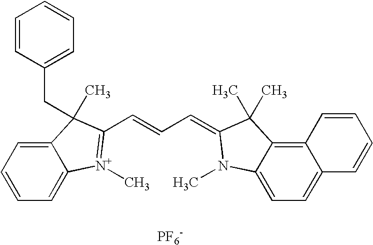 |

TABLE 13

| Sample No. | |
|---|---|
| 1 | S1 (100) |
| 2 | S2 (50) + S6 (50) |
| 3 | S3 (50) + S6 (50) |
| 4 | S4 (50) + S8 (50) |
| 5 | S5 (40) + S9 (60) |
| 6 | S4 (100) |
| 7 | S3 (100) |
| 8 | S3 (100) + S6 (100) |
| 9 | S9 (100) |

The apparatus used for thermogravimetry (and differential thermal analysis) was a TG/DTA22 by Seiko Electronics Corp.; a 2 mg portion of the sample was set in the sample holder while a reference sample was set in a reference holder, and after initiating circulation of He gas in the apparatus at a flow rate of 300 mL/min as the ambient gas around the sample, the temperature was raised from room temperature using a temperature elevating program with a temperature elevating rate of 10° C./min, and the change in weight of the sample was measured. The maximum values for each weight reduction (%/° C.) at 180-250° C. as calculated from the obtained TG curve are shown in Table 14.

TABLE 14

| | Maximum values of weight |
|---|---|
| | reduction at 180-250° C. |
| Sample No. | (%/° C.) |
| 1 | 0.23 |
| 2 | 0.72 |
| 3 | 2.98 |
| 4 | 1.49 |
| 5 | 0.44 |
| 6 | 0 |
| 7 | 9.84 |
| 8 | 3.52 |
| 9 | 0.47 |

Based on the results of TG and the types of dye materials, sample Nos. 1-5 were used as the dye components for Examples 1-5, and sample Nos. 6-9 were used as the dye components for Comparative Examples 1-4.

### Example 1

First, a polycarbonate resin base with a 120 mm diameter and a 0.6 mm thickness was prepared, having a pre-groove (0.12 μm depth, 0.30 μm width, 0.74 μm groove pitch) formed on one side. Separately, a dye component composed of the same material as sample No. 1 was added to 2,2,3,3-tetrafluoropropanol to a content of 1.0 wt % to prepare a recording layer coating solution. The obtained coating solution was applied onto the side of the aforementioned polycarbonate resin base on which the pre-groove had been formed, and dried at 80° C. for 1 hour to form a recording layer (150 nm thickness). Next, an Ag reflective film (100 nm thickness) was formed on the recording layer by sputtering, and an ultraviolet curing resin SD-1700 (trade name of Dainippon Ink & Chemical Industries Co., Ltd.) was coated onto the Ag reflective layer by spin coating and then subjected to ultraviolet irradiation to form a transparent protective layer (8 μm thickness) composed of an acryl resin. Also, an ultraviolet curing resin SD-301 (trade name of Dainippon Ink & Chemical Industries Co., Ltd.) was coated onto the protective layer. Next, another identical transparent base with a thickness of 0.6 mm was laminated thereover and the excess ultraviolet curing resin was removed by high-speed spinning. Ultraviolet light was then irradiated through the laminated transparent bases for curing of the ultraviolet curing resin to form an adhesive layer, which was used to attach the protective layer and transparent bases in order to fabricate an optical recording medium (optical recording disk) for Example 1.

### Examples 2-5 and Comparative Examples 1-4

Optical recording disks for Examples 2-5 and Comparative Examples 1-4 were obtained in the same manner as Example 1, except that the dye components used were composed of the same materials as sample Nos. 2-9 instead of the same material as sample No. 1.

(Evaluation of Recording/Reading Characteristics)

The optical recording media of Examples 1-5 and Comparative Examples 1-4 were irradiated with laser light of 650 nm wavelength using an optical disk evaluating apparatus (trade name: DDU-1000) by Pulstec Industrial Co., Ltd., for recording of a signal at a linear speed of 28 m/sec. The lens numerical aperture NA of the optical head mounted on the apparatus was 0.60. The recording was performed with a recording power which yielded an eye pattern with the eye center positioned at the center of a 14T waveform (see Table 15). After recording, the PI (Inner-code-parity) error (number of errors per 1 ECC block) value was determined. Each optical recording medium was set in a 100,000 lux light resistance tester and subjected to a light irradiation test at 60° C. for 40 hours (cumulative illumination: 4 Mlux·hr), and the PI error after the light irradiation test was also determined. The results are shown in Table 15.

A PI error of 280 or lower satisfies the DVD product standard. “Unrecordable” in the table means that no recording was possible even with the apparatus at maximum recording power, and “unmeasurable” means that the PI error value was so large that it was beyond the measuring limit of the apparatus.

TABLE 15

| | | | | PI error after |
|---|---|---|---|---|
| | Sample | Recording power | | light |
| | No. | (mW) | PI error | irradiation test |
| Example 1 | 1 | 33 | 81 | 101 |
| Example 2 | 2 | 33 | 76 | 99 |
| Example 3 | 3 | 28 | 55 | 78 |
| Example 4 | 4 | 26 | 18 | 32 |
| Example 5 | 5 | 26 | 16 | 28 |
| Comp. Ex. 1 | 6 | unrecordable | — | — |
| Comp. Ex. 2 | 7 | 26 | 470 | unmeasurable |
| Comp. Ex. 3 | 8 | 27 | 291 | unmeasurable |
| Comp. Ex. 4 | 9 | 26 | 12 | unmeasurable |

The results of the recording/reading characteristic evaluation indicated that the optical recording media employing dye components wherein the maximum value of the weight reduction (%/° C.) at 180-250° C. was in the range of 0.2-3.0%/° C. had sufficiently minimized PI error with high-speed recording, and thus exhibited very satisfactory recording characteristics. A comparison of Example 5 and Comparative Example 4 demonstrates that including a chelate compound of an azo compound and a metal can further reduce deterioration of the recording characteristics after a light irradiation test.

What is claimed is:

1. An optical recording material used for an optical recording medium capable of recording information by irradiation of light,
said optical recording medium being an optical recording medium which records information at a linear speed of at least 14 m/sec,
wherein the dye component in said optical recording material comprises at least one type of chelate compound of an azo compound and a metal,
and when said dye component is used as a sample for thermogravimetry in an inert gas atmosphere, said dye component sample exhibits a maximum weight reduction of 0.2-3.0%/° C. at 180-250° C.

2. An optical recording material according to claim 1, wherein said maximum weight reduction at 180-250° C. in said thermogravimetry is in the range of 0.2-3.0%/° C.

3. An optical recording material according to claim 1, wherein said azo compound includes an azo compound represented by the following general formula (1). 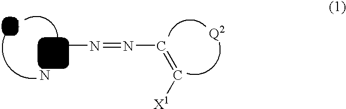
(wherein Q¹ represents a divalent residue which binds to the nitrogen atom and to the carbon atom bound to the nitrogen atom to form a heterocycle or a fused ring containing said heterocycle, Q² represents a divalent residue which binds to the mutually bound carbon atoms to form a fused ring, and X¹ represents a functional group with one or more active hydrogen atoms).

4. An optical recording material according to claim 1, wherein said dye component contains a cyanine dye.

5. An optical recording material according to claim 4, wherein said cyanine dye has a group represented by the following general formula (2) or (3). 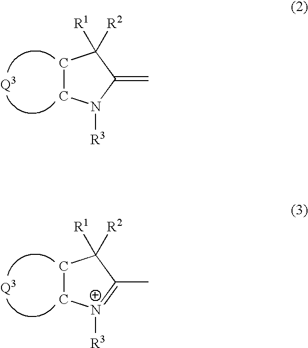
(wherein Q³ represents an optionally substituted benzene ring or an optionally substituted naphthalene ring, R¹ and R² each independently represent C1-4 alkyl, cycloalkyl, phenyl or optionally substituted benzyl, or are linked together to form a 3- to 6-membered ring, and R³ represents C1-4 alkyl, cycloalkyl, alkoxy, phenyl or optionally substituted benzyl, the groups represented by R¹, R² and R³ being optionally substituted).

6. An optical recording medium capable of recording information at a linear speed of at least 14 m/sec by irradiation of light,
wherein the recording layer provided on said optical recording medium comprises as a constituent material a dye component containing at least one type of chelate compound of an azo compound and a metal,
and when said dye component is used as a sample for thermogravimetry in an inert gas atmosphere, said sample exhibits a maximum weight reduction of 0.2-3.0%/° C. at 180-250° C.

7. An optical recording medium according to claim 6, wherein said maximum weight reduction at 180-250° C. in said thermogravimetry is in the range of 0.2-3.0%/° C.

8. An optical recording medium according to claim 6, wherein said azo compound includes an azo compound represented by the following general formula (1). 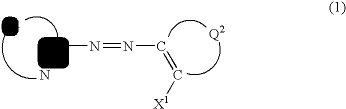
(wherein Q¹ represents a divalent residue which binds to the nitrogen atom and to the carbon atom bound to the nitrogen atom to form a heterocycle or a fused ring containing said heterocycle, Q² represents a divalent residue which binds to the mutually bound carbon atoms to form a fused ring, and X¹ represents a functional group with one or more active hydrogen atoms).

9. An optical recording medium according to claim 6, wherein said dye component contains a cyanine dye.

10. An optical recording medium according to claim 9, wherein said cyanine dye has a group represented by the following general formula (2) or (3). 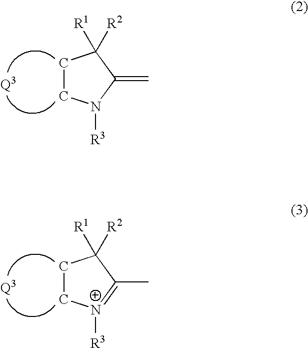
(wherein Q³ represents an optionally substituted benzene ring or an optionally substituted naphthalene ring, R¹ and R² each independently represent C1-4 alkyl, cycloalkyl, phenyl or optionally substituted benzyl, or are linked together to form a 3- to 6-membered ring, and R³ represents C1-4 alkyl, cycloalkyl, alkoxy, phenyl or optionally substituted benzyl, the groups represented by R¹, R² and R³ being optionally substituted).
